(19) United States
(12) Patent Application Publication
(10) Pub. No.: US 2010/0230013 A1
(43) Pub. Date: Sep. 16, 2010

(54) R-T-B ALLOY, PROCESS FOR PRODUCTION OF R-T-B ALLOY, FINE POWDER FOR R-T-B RARE EARTH PERMANENT MAGNETS, AND R-T-B RARE EARTH PERMANENT MAGNET

(75) Inventor: Kenichiro Nakajima, Chichibu-shi (JP)

Correspondence Address: SUGHRUE MION, PLLC, 2100 PENNSYLVANIA AVENUE, N.W., SUITE 800, WASHINGTON, DC, 20037, US

(73) Assignee: SHOWA DENKO K.K., Tokyo (JP)

(21) Appl. No.: 12/744,452

(22) PCT Filed: Dec. 12, 2008
(86) PCT No.: PCT/JP2008/072635

§ 371 Date: May 24, 2010

(30) Foreign Application Priority Data
Dec. 13, 2007 (JP) 2007-322059

(51) Int. Cl. B22D 27/04; B22D 23/00; H01F 1/01; B22D 25/00; C22C 38/00

(52) U.S. Cl. 148/538; 148/306

(57) ABSTRACT

An R-T-B alloy used in a rare earth permanent magnet, where R is at least one element selected from rare earth elements including Y, which contains Dy and/or Tb as an essential element, T is a metal comprising Fe as an essential element, and B is boron, comprising: a main phase being an R₂T₁₄B phase, and an R-rich phase; and when a mean value of the concentration of Dy and/or Tb in the whole of said R-T-B alloy is defined as an average concentration, an area of 60% or more of an area of said main phase in an arbitrary cross-section of said R-T-B alloy contains said Dy and/or Tb at the average concentration or higher; a process for the production of the R-T-B alloy; a fine powder for R-T-B rare-earth permanent magnets which is prepared from the R-T-B alloy: R-T-B rare earth permanent magnet, and motors.

### TECHNICAL FIELD

The present invention relates to an R-T-B alloy, a process for the production of an R-T-B alloy, a fine powder for R-T-B rare earth permanent magnets, and an R-T-B rare earth permanent magnet. In particular, it relates to an R-T-B alloy and a fine powder for R-T-B rare earth permanent magnets whereby R-T-B rare earth permanent magnets with excellent uniformity of magnetization can be obtained.

### BACKGROUND ART

In recent years, demand for motors using rare-earth magnets has been increasing against a background of strong demand for energy saving. In rare-earth magnets for use in motors, heavy rare earth elements such as Dy, Tb and the like are utilized in order to improve heat resistance. However, a reduction is required in heavy rare earth elements added to rare earth magnets because of resource limitations. Furthermore, if heavy rare earth elements are added, the remanence of a sintered magnet is reduced, so that the energy of the rare-earth magnet itself is reduced. Therefore, in order to obtain a rare-earth magnet having high energy, it is required to obtain as high a coercive force as possible using as low an amount of heavy rare earth elements as possible.

In an R-T-B magnet alloy, R is mainly Nd, part of which is substituted by another rare earth element such as Pr, Dy, Tb or the like, and which is at least one type of rare earth element including Y. T is Fe, part of which is substituted by another transition metal such as Co, Ni or the like. B is boron, part of which can be substituted by C or N. Because the main elements are Nd, Fe and B, it is referred to as an Nd—Fe—B alloy, or an R-T-B alloy. As additional elements, one or a plurality of combinations of Cu, Al, Ti, V, Cr, Ga, Mn, Nb, Ta, Mo, W, Ca, Sn, Zr, Hf or the like may be added.

An R-T-B alloy has an R₂T₁₄B phase, which is a strong magnetic phase contributing to the magnetization effect, as its main phase. In the main phase, a non-magnetic R-rich phase with a low melting point coexists in which rare earth elements are concentrated. Since an R-T-B alloy is an active metal, melting and casting are performed in a vacuum or inert gas. Moreover, in order to produce a sintered magnet from an R-T-B alloy ingot cast using a powder metallurgy method, after an ingot of the alloy is pulverized to an alloy powder of about 5 μm (as measured using a laser diffraction type grain size distribution measuring instrument), it is formed using a press in a magnetic field to orientate it in the direction of the axis of easy magnetization, and is sintered in a sintering furnace between about 1000° C. to 1100° C. in a vacuum or inert atmosphere. Afterward, it is usual to form a sintered magnet by performing heat treatment and machining as required, and furthermore, by applying plating in order to improve the corrosion resistance.

In an R-T-B sintered magnet, the R-rich phase performs the following important functions.

1) Since it has a low melting point, it turns to the liquid phase during sintering, thereby contributing to a magnet with a high density and with improved magnetization.
2) It smoothes grain boundaries, thereby reducing the number of nucleation sites in reversed magnetic domains, thereby enhancing the coercive force.
3) It magnetically insulates the main phase, thereby enhancing the coercive force.

Accordingly, if the distribution state of the R-rich phase in the molded magnet is abnormal, it causes localized sintering failure and reduction of magnetism. Therefore, it is important for the R-rich phase to be distributed in the molded magnet uniformly. The distribution of the R-rich phase in a magnet is affected greatly by the structure of the R-T-B alloy, being its raw material.

Furthermore, a problem occurring in casting R-T-B alloy is that α-Fe is formed in the cast alloy. α-Fe degrades the pulverizing efficiency when the alloy is being pulverized.

Moreover, if α-Fe remains in the magnet after sintering, it reduces the magnetic characteristics of the magnet. Therefore, in a conventional R-T-B alloy, homogenization is performed for a long time at a high temperature as required to eliminate the α-Fe.

In order to solve the problem that α-Fe is formed in R-T-B alloys, a strip casting method (abbreviated to SC method) has been developed, and is in practical use as a method of casting alloy ingots at a faster cooling rate. The SC method is a technique in which by pouring molten metal on a copper roll whose inside is water-cooled, and casting flakes approximately 0.1 to 1 mm thick, the alloy is rapidly solidified. By using the SC method, it is possible to suppress the deposition of α-Fe. Furthermore, by using the SC method, since the crystal structure of the alloy becomes fine, it is possible to produce an alloy having a structure in which the R-rich phase is distributed finely.

It is known that in this manner, since the R-rich phase of the inside of the alloy cast by the SC method is distributed finely, dispersion of the R-rich phase in a magnet after pulverization and sintering becomes satisfactory, making magnets with excellent magnetic characteristics (for example, refer to Patent Document 1 and Patent Document 2).

Moreover, an alloy flake cast by the SC method is excellent in the homogeneity of its structure. The homogeneity of the structure can be compared by the grain size or the distribution state of the R-rich phase. In an alloy flake produced by the SC method, while chill crystals may be generated on the casting roller side (hereunder referred to as the mold surface side) of the alloy flake, a suitably fine and homogeneous structure formed by quench solidification can be obtained overall.

As described above, the R-T-B alloy cast by the SC method has an excellent structure suited to the production of a sintered magnet since the R-rich phase is finely dispersed and the formation of α-Fe is suppressed. However, as the characteristics of magnets have improved, higher control of the structure of the raw material alloy has been required, especially the state of presence of the R-rich phase.

Previously, the present inventors have studied the relationship between the structure of cast R-T-B alloy and the behavior at the time of hydrogen decrepitation and pulverization, and discovered that it is important to control the distribution state of the R-rich phase in order to maintain a uniform grain size of the sintered magnet alloy powder.

The present inventors discovered that the area (fine R-rich phase area) where the distribution state of the R-rich phase formed on the mold surface side of the alloy is extremely fine is likely to be pulverized to fine powder, so that the pulverization stability of the alloy is reduced, and the particle size distribution of the powder is broadened. They confirmed that it is necessary to reduce the fine R-rich phase region in order to improve the magnetic characteristics (for example, refer to Patent Document 3, Patent Document 4, and Patent Document 5).

Furthermore, it is known that there is a problem in that, in a raw material alloy for a rare earth permanent magnet, which is produced using a quenching method and has at least one type of R_{H} selected from a group consisting of Tb and Ho, part of the R_{H} in the alloy, which exists in a grain boundary phase, is not used effectively in improving the coercive force. In order to solve this problem, a technique is proposed in which R_{H} is 10 atomic percent or more of the whole of the rare earth elements contained, and the proportion of the number of atoms of the R_{H} contained in the R₂T₁₄Q phase is greater than the proportion of the number of atoms of the R_{H} contained in the whole of the rare earth elements, so that the R_{H} is used efficiently to improve the coercive force effectively (for example, refer to Patent Document 6).

Patent Document 1: Japanese Unexamined Patent Application, First Publication No. 1993-222488

Patent Document 2: Japanese Unexamined Patent Application, First Publication No. 1993-295490

Patent Document 3: Japanese Unexamined Patent Application, First Publication No. 2003-188006

Patent Document 4: Japanese Unexamined Patent Application, First Publication No. 2004-43921

Patent Document 5: Japanese Unexamined Patent Application, First Publication No. 2004-181531

Patent Document 6: Japanese Unexamined Patent Application, First Publication No. 2007-67419

### DISCLOSURE OF INVENTION

### Problems to be Solved by the Invention

While the dispersion of the magnetic properties is large in a conventional R-T-B rare earth permanent magnet, there is an inconvenience of insufficient uniformity. Therefore, there is a requirement to reduce the dispersion of the magnetic properties.

The present invention has been made in consideration of the above circumstances with an object of providing an R-T-B alloy, which is a raw material of an R-T-B rare earth permanent magnet, having low dispersion of magnetic properties and excellent uniformity of magnetization, and a process for producing an R-T-B alloy.

Furthermore, it has objects of providing a fine powder for R-T-B rare earth permanent magnets, and an R-T-B rare earth permanent magnet, that are produced from the R-T-B alloy.

### Means for Solving the Problems

The present inventor found out that in an R-T-B alloy containing Dy and/or Tb, the distribution of Dy and/or Tb in the R-T-B alloy has an influence on the magnetic characteristics obtained after pulverization and sintering, and devoted himself to keen research focussing on the concentration of Dy and/or Tb contained in the main phase, being the R₂T₁₄B phase. To be specific, the present inventor performed area analysis of the concentration of Dy and/or Tb in the R-T-B alloy using a field emission type electron probe micro-analysis (EPMA). As a result, although the amount of the rare earth elements contained in the main phase was considered to be uniform conventionally, it has been clarified that it varies depending on the location.

Therefore, the present inventor investigated the relationship between the concentration distribution of Dy and/or Tb contained in the main phase and the dispersion of the magnetic properties. As a result, the present inventor discovered that where there is sufficiently low dispersion in the concentration of Dy and/or Tb contained in the main phase, the dispersion of the magnetic properties becomes sufficiently low, leading to the present invention.

That is, the present invention is to provide the following aspects.

(1) An R-T-B alloy used in a rare earth permanent magnet (where R is at least one element selected from rare earth elements including Y, which contains Dy and/or Tb as an essential element, T is a metal comprising Fe as an essential element, and B is boron), which has a main phase, being an R₂T₁₄B phase, and an R-rich phase, and when a mean value of the concentration of Dy and/or Tb in the whole of the R-T-B alloy is defined as an average concentration, an area of 60% or more of an area of the main phase in an arbitrary cross-section of the R-T-B alloy contains the Dy and/or Tb at the average concentration or higher.

(2) An R-T-B alloy according to (1), wherein an area of 10% or more of an area of the main phase contains 1% or more by mass of higher than the average concentration of Dy and/or Tb.

(3) An R-T-B alloy according to (1) or (2), wherein a distance between the R-rich phases is 3 μm to 10 μm.

(4) An R-T-B alloy according to any one of (1) to (3), wherein an amount of Dy and/or Tb contained in the main phase of the Dy and/or Tb contained in the whole of the R-T-B alloy is 75% by mass to 90% by mass, and a dispersion of a concentration of Dy and/or Tb in the main phase is 2% or less by mass.

(5) An R-T-B alloy according to any one of (1) to (4) that is a flake with an average thickness of 0.05 mm to 0.8 mm, produced using a strip casting method.

Furthermore, the present inventor devoted himself to keen research concerning a process for producing an R-T-B alloy in which the dispersion of the concentration of Dy and/or Tb contained in the main phase is sufficiently low. Then he discovered that by reducing the cooling rate in a specific temperature zone, and performing diffusion of R sufficiently, it is possible to reduce the dispersion of the concentration of Dy and/or Tb contained in the main phase, leading to the present invention.

(6) A process for producing an R-T-B alloy according to any one of (1) to (5), comprising; a casting step using a strip casting method, and a temperature maintaining heat treatment step for maintaining a cast alloy at a temperature of 900° C. to 600° C. for 10 seconds to 7200 seconds.

(7) A process for producing an R-T-B alloy according to (6), wherein in the casting step, an alloy temperature when it is removed from a cooling roller is between 650° C. and 1100° C.

(8) A process for producing an R-T-B alloy according to (6) or (7), wherein a temperature of the alloy when starting the temperature maintaining heat treatment step is between 950° C. and 600° C.

(9) A fine powder for R-T-B rare earth permanent magnets that is produced from an R-T-B alloy according to any one of (1) to (5), or an R-T-B alloy produced using a process for producing an R-T-B alloy according to any one of (6) to (8).

(10) An R-T-B rare earth permanent magnet that is produced from a fine powder for R-T-B rare earth permanent magnets according to (9).

(11) A motor, wherein an R-T-B rare earth permanent magnet according to (10) is used.

### EFFECTS OF THE INVENTION

An R-T-B alloy of the present invention has a main phase, being an R₂T₁₄B phase, and an R-rich phase, and when the mean value of the concentration of Dy and/or Tb in the whole of the R-T-B alloy is defined as the average concentration, an area of 60% or more of the area of the main phase in an arbitrary cross-section of the R-T-B alloy contains Dy and/or Tb at the average concentration or higher. Since the concentration of Dy and/or Tb in the main phase is high, and the dispersion of the concentration of Dy and/or Tb in the main phase is low, it is possible to realize an R-T-B rare earth permanent magnet with low dispersion of its magnetic properties and excellent uniformity of magnetization.

Since a process for producing an R-T-B alloy of the present invention has a casting step that uses a strip casting method, and a temperature maintaining heat treatment step for maintaining the cast alloy at a temperature of 900° C. to 600° C. for 10 seconds to 7200 seconds, the diffusion of R is performed sufficiently, lowering the dispersion of the concentration of Dy and/or Tb contained in the main phase, so that an R-T-B alloy of the present invention can be obtained in which the concentration of Dy and/or Tb contained in the main phase is high, and the dispersion of the concentration of Dy and/or Tb in the main phase is low.

Moreover, since a fine powder for R-T-B rare earth permanent magnets and an R-T-B rare earth permanent magnet of the present invention are produced from an R-T-B alloy produced using an R-T-B alloy of the present invention or a process for producing an R-T-B alloy of the present invention, they have low dispersion of their magnetic properties and excellent uniformity of magnetization.

### BRIEF DESCRIPTION OF THE DRAWINGS

FIG. 1 is a schematic diagram of a casting apparatus of a strip casting method.

FIG. 2A is a photograph showing a result of an EPMA analysis of a cast alloy flake of example 1, and is a backscattered electron image projected on the surface of a casting roller in the vertical direction.

FIG. 2B is a photograph showing a result of an EPMA analysis of a cast alloy flake of example 1, and is an electron image showing a result of an area analysis (digital mapping) of Dy in the same area as in FIG. 2A.

FIG. 3A is a photograph showing a result of an EPMA analysis of a cast alloy flake of comparative example 1, and is a backscattered electron image projected on the surface of a casting roller in the vertical direction.

FIG. 3B is a photograph showing a result of an EPMA analysis of a cast alloy flake of comparative example 1, and is an electron image showing a result of an area analysis (digital mapping) of Dy in the same area as in FIG. 3A.

FIG. 4 is a graph showing area ratios of the areas of a main phase that have a Dy concentration higher than the average concentration by 1% or more by mass.

FIG. 5 is a graph showing area ratios of the areas of a main phase that have a Dy concentration higher than the average concentration.

FIG. 6 is a graph showing the saturation magnetization (Js) of the R-T-B rare earth permanent magnets of example 1 and comparative example 1.

FIG. 7 is a graph showing the remanence (Br) of the R-T-B rare earth permanent magnets of example 1 and comparative example 1.

FIG. 8 is a graph showing the orientation (Br/Js) of the R-T-B rare earth permanent magnets of example 1 and comparative example 1.

FIG. 9 is a graph showing the coercive force (Hcj) of the R-T-B rare earth permanent magnets of example 1 and comparative example 1.

FIG. 10 is a graph showing the squareness (Hk/Hcj) of the R-T-B rare earth permanent magnets of example 1 and comparative example 1.

FIG. 11A is a diagram showing an example of a motor of the present invention, and is a schematic cross-sectional diagram showing the rotor structure section of an IPM type motor.

FIG. 11B is a diagram showing an example of a motor of the present invention, and is a schematic cross-sectional diagram showing the rotor structure section of an SPM type motor.

### DESCRIPTION OF THE REFERENCE SYMBOLS

1 Refractory Crucible
2 Tundish
3 Casting Roller
4 Collecting Container
5 R-T-B Alloy
11, 15 Permanent Magnet
12, 16 Rotating Shaft
13, 17 Aperture

### BEST MODE FOR CARRYING OUT THE INVENTION

An R-T-B alloy of the present invention is used for rare earth permanent magnets. In the R-T-B alloy of the present invention, R is at least one element selected from rare earth elements including Y, which contains Dy and/or Tb as an essential element; T is a metal comprising Fe as an essential element, and B is boron. Furthermore, in the R-T-B alloy of the present invention, the R content is 27.5 to 32.5%, the B content is 0.87 to 1.30%, and the remainder is T. The R-T-B alloy of the present invention may include Al, Cu, Co, Ga, or the like as additives. The amount of the additives may be Co of 0.5 to 3% by mass, Cu of 0.05 to 0.2% by mass, Ga of 0.05 to 0.3% by mass, and Al of 0.03 to 0.5% by mass, for example.

Moreover, the R-T-B alloy of the present invention comprises a main phase, being an R₂T₁₄B phase, and a non-magnetic R-rich phase having a low melting point, in which the R content is 70% by mass or greater, and the rare earth elements are concentrated. The main phase is made mainly from columnar crystals with part being equiaxed crystals. The R-rich phase exists in the grain boundaries and the grains of the main phase, extends linearly along the major axis direction of the columnar crystals of the main phase, or is partially discontinuous, or granular.

It is preferable that the distance between the R-rich phases is 3 μm to 10 μm. If the distance between the R-rich phases is less than 3 μm, there is concern that it will have an adverse effect in which the crystal grains become too fine. Furthermore, if the distance between the R-rich phases exceeds 10 μm, the state of dispersion of the R-rich phase deteriorates, and in the case where the R-T-B alloy is pulverized to produce a powder for R-T-B rare earth permanent magnets, the proportion of the powder particles in which the R-rich phase exists is reduced, so that the state of the distribution of the R-rich phase deteriorates. Therefore, there is concern about a drop in the degree of sintering and concern that a sufficient coercive force cannot be obtained in the sintered magnet.

Moreover, in the R-T-B alloy of the present invention, when the mean value of the concentration of Dy and/or Tb in the whole of the R-T-B alloy is defined as the average concentration, an area of 60% or more of the area of the main phase in an arbitrary cross-section of the R-T-B alloy contains the average concentration or more of Dy and/or Tb.

Here, “the average concentration of Dy and/or Tb” is defined as being the concentration in the raw materials of the R-T-B alloy. However, in the case where the concentration in the raw materials is not known, it can be calculated using a method in which the R-T-B alloy is dissolved in acid and measured using an ICP (Inductively Coupled Plasma), or using a method in which the R-T-B alloy is sintered as an oxide and measured using XRF (X-ray fluorescence analysis).

Furthermore, “the concentration of Dy and/or Tb in the main phase” can be obtained using a method of area analysis of the main phase parts in an arbitrary cross-section of the R-T-B alloy using an EPMA (electron probe microanalyzer). Regarding the EPMA, it is preferable to use a thermal electron emission type of tungsten filament or a field emission type since it has high definition and high accuracy.

If the area of the main phase that contains the average concentration or more of Dy and/or Tb is less than the above range, the concentration of Dy and/or Tb in the main phase is reduced (in other words, the concentration of Dy and/or Tb in the R-rich phase is increased), the proportion of Dy and/or Tb that cannot be used effectively for the improvement of coercive force increases resulting in inadequate magnetic properties, the dispersion of the concentration of Dy and/or Tb in the main phase is increased, and the dispersion of the magnetic properties is increased so that the uniformity of magnetization become inadequate.

Moreover, in the R-T-B alloy of the present invention, it is preferable for an area of 10% or more of the area of the main phase to contain Dy and/or Tb at 1% or more by mass higher than the average concentration.

In the case where the R-T-B alloy is pulverized to produce a fine powder for R-T-B rare earth permanent magnets, since the Dy and/or Tb contained in the R-rich phase is likely to be oxidized at the time of pulverization of the R-T-B alloy and to be formed as a stable oxidized substance compared with the Dy and/or Tb contained in the main phase, it is likely that it is not used for improvement of the coercive force of a sintered magnet. Therefore, if the proportion of the area where the concentration of Dy and/or Tb is greater than the average concentration by 1% or more by mass is less than the above-described range, the concentration of Dy and/or Tb in the R-rich phase increases, increasing the amount of Dy and/or Tb lost at the time of pulverization when producing a fine powder for R-T-B rare earth permanent magnets, so that there is concern about inadequate magnetic properties.

Furthermore, it is preferable that the amount of Dy and/or Tb contained in the main phase of the R-T-B alloy of the present invention is 75% by mass to 90% by mass of the Dy and/or Tb contained in the whole of the R-T-B alloy, and that the dispersion of the concentration of Dy and/or Tb in the main phase is less than or equal to 2% by mass. “The amount of Dy and/or Tb contained in the main phase” and “the dispersion of the concentration of Dy and/or Tb in the main phase” can be calculated using the results of area analysis of the main phase parts in an arbitrary cross-section of the R-T-B alloy using an EPMA.

By setting the amount of Dy and/or Tb contained in the main phase out of the Dy and/or Tb contained in the whole of the R-T-B alloy to the above range, and setting the dispersion of the concentration of Dy and/or Tb in the main phase to less than or equal to the above range, the concentration of Dy and/or Tb in the main phase becomes sufficiently high, and the dispersion of the concentration of Dy and/or Tb in the main phase becomes sufficiently low.

Moreover, in the case where the R-T-B alloy of the present invention is a flake with an average thickness of 0.05 mm to 0.8 mm produced using an SC method, the distance between R-rich phases is approximately 3 μm to 10 μm, which is desirable. If the average thickness of the flake is less than 0.05 mm, the cooling rate when producing using a strip casting method increases excessively, and hence the dispersion of the R-rich phase becomes too fine. Furthermore, if the average thickness of the flake exceeds 0.8 mm, the cooling rate when producing using the SC method decreases, so there are concerns about a degradation of the dispersibility of the R-rich phase, and formation of α-Fe.

### (Production of R-T-B Rare Earth Permanent Magnet)

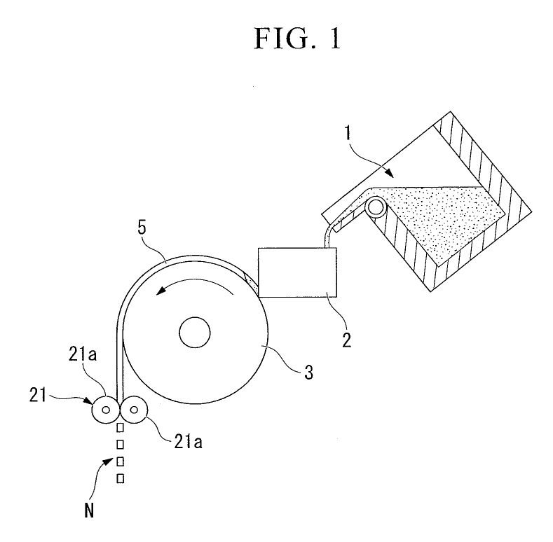

In order to produce an R-T-B rare earth permanent magnet, firstly a fine powder for R-T-B rare earth permanent magnets is produced from an R-T-B alloy of the present invention. The R-T-B alloy of the present invention is produced using an SC method using a casting apparatus as shown in FIG. 1.

### (Casting Step)

Firstly, a raw material for an R-T-B alloy of the present invention is charged into a refractory crucible 1 shown in FIG. 1, which is made from alumina, and melted in an inert gas atmosphere such as a vacuum or argon at a temperature raised to around 1500° C. to form molten metal. The raw material used may, for example, have a rare earth element including Y, which contains Dy and/or Tb as an essential element, and Fe and ferroboron as its main elements, and contain aluminum, copper, cobalt, and gallium as additives for adjusting the magnetic properties.

Next, the molten metal of the alloy is fed to a casting roller 3 (cooling roller) whose inside is water cooled and which rotates at a rotating speed of 1.0 m/s, via a tundish 2 provided with a rectification mechanism or slug removal mechanism as required, at a feed rate of 25 g/sec per a feed width of 1 cm and solidified on the casting roller 3 to form a flake with an average thickness of 0.05 mm to 0.8 mm. The solidified flake of an R-T-B alloy 5 detaches from the casting roller 3 on the side opposite the tundish 2, and by being crushed between crushing rollers 21 a of a crushing equipment 21, it is crushed to a diameter of 1 cm or less to form cast alloy flakes N, and transferred to a heat-treatment apparatus (not shown in the figure).

### (Average Cooling Rate on Alloy Casting Roller)

The average cooling rate is the result of the division of the difference between the temperature immediately before the molten metal makes contact with the casting roller and the temperature when the alloy leaves the casting roller, by the duration of the contact with the casting roller. The average cooling rate is preferably in the range of 500° C. to 3000° C. per second. If the average cooling rate is less than 500° C. per second, the cooling rate becomes insufficient, causing formation of α-Fe, and a rough and coarse formation of the R-rich phase, the R₂T₁₇ phase, and the like. On the other hand, if the average cooling rate exceeds 3000° C. per second, it causes supercooling, so there is concern that the dispersion of the concentration of Dy and/or Tb in the main phase cannot be sufficiently lowered.

(Alloy Temperature when Detaching from Casting Roller)

The roller detaching temperature, which is the average temperature of the alloy when detaching from the casting roller, changes subtly depending on subtle differences in the contact of the alloy with the casting roller, fluctuations in the thickness of the alloy, and the like. The roller leaving temperature can be measured, for example, by a method in which the alloy surface is scanned in the widthwise direction from the start time of casting to the finish time using a radiation thermometer, and the measured values are averaged. The roller leaving temperature is preferably approximately 650° C. to 1100° C., and more preferably 750° C. to 1000° C. In the case where the roller leaving temperature is in the range of 650° C. to 1100° C., it is possible to perform a heat-retaining heat treatment step without reheating after the casting step.

The melting temperature of the main phase is approximately 1150° C. in a ternary compound system of Nd—Fe—B. However, it changes depending on the substitution of Nd with another rare earth element, the substitution of Fe with another transition element, the type of other additional elements, and the amount of the addition. In the case where the difference between the melting point of the main phase and the roller leaving temperature is less than 50° C., it causes an insufficient cooling rate. On the other hand, in the case where the difference between the melting point of the main phase and the roller leaving temperature is greater than 500° C., the cooling rate is too fast, which causes supercooling of the molten metal. The degree of supercooling of the molten metal is not uniform in the alloy, and it changes depending on the degree of contact of the alloy with the casting roller, and the distance from the part of the alloy in contact with the casting roller.

### (Temperature Maintaining Heat Treatment Step)

The cast alloy flakes N transferred to a heat maintaining apparatus are collected by a temperature maintaining container, which is preheated by a heater, and are subjected to a temperature maintaining heat treatment step in which they are maintained at a temperature of 900° C. to 600° C. for 10 seconds to 7200 seconds, preferably for 30 seconds to 1800 seconds. Since the cast alloy flakes N obtained after detaching from the casting roller and being crushed are likely to dissipate their heat to the surroundings, it is preferable to perform the temperature maintaining heat treatment step immediately after crushing in order to perform the temperature maintaining heat treatment step adequately.

If the temperature of the temperature maintaining heat treatment step is below the above range, or if the processing time is less than the above range, there is concern that the distribution of Dy and/or Tb in the main phase does not become sufficiently uniform.

Furthermore, if the temperature of the temperature maintaining heat treatment step exceeds the above range, or if the processing time exceeds the above range, the crystal structure of the alloy grows, which is not desirable. If the temperature maintaining heating time is set to be long, growth of the crystal structure progresses, but if the temperature maintaining heating time exceeds a predetermined time, the growth of the crystal structure will almost converge. However, in order to improve productivity, it is desirable for the processing time of the temperature maintaining heat treatment step to be less than 7200 seconds.

Moreover, the temperature of the cast alloy flakes N when starting the temperature maintaining heat treatment step is preferably 950° C. to 600° C., and more preferably in a range of 850° C. to 700° C. If the temperature of the cast alloy flakes N when starting the temperature maintaining heat treatment step is less than the above range, there is concern that the distribution of Dy and/or Tb in the main phase does not become sufficiently uniform. Furthermore, if the temperature of the cast alloy flakes N when starting the temperature maintaining heat treatment step exceeds the above range, there is concern that the crystal structure of the alloy becomes coarse.

Moreover, the desirable temperature of the cast alloy flakes N when starting the temperature maintaining heat treatment step varies depending on the elements contained in the cast alloy flakes N. For example, in the case of cast alloy flakes N where TRE (Nd+Pr+Dy) is 30.5 to 31.5% by weight, and Dy is contained in the TRE at 2.0 to 2.5% by weight, the temperature is preferably in a range of 680° C. to 800° C., and the average temperature is preferably approximately 750° C. Furthermore, in the case of cast alloy flakes N where TRE (Nd+Pr+Dy) is 27.5 to 28.5% by weight, and Dy is contained in the TRE at 5.0 to 5.5% by weight, the temperature is preferably in a range of 720° C. to 780° C., and the average temperature is preferably approximately 750° C. Moreover, in the case of cast alloy flakes N where TRE (Nd+Pr+Dy) is 31.0 to 32.5% by weight, and Dy is contained in the TRE at 7.5 to 8.0% by weight, the temperature is preferably in a range of 720° C. to 800° C., and the average temperature is preferably approximately 750° C. Furthermore, in the case of cast alloy flakes N where TRE (Nd+Pr+Dy) is 30.5 to 31.0% by weight, and Dy is contained in the TRE at 8.5 to 9.0% by weight, the temperature is preferably in a range of 730° C. to 820° C., and the average temperature is preferably approximately 770° C.

The temperature control apparatus used for the temperature maintaining heat treatment step is not specifically defined, and any type is acceptable provided it can perform an adequate temperature maintaining heat treatment step. However, examples can be given such as; one provided with a belt conveyer for conveying temperature maintaining containers, one provided with a tipping device which tips a temperature maintaining container to transfer cast alloy flakes in the temperature maintaining container to a storage container, or a temperature maintaining container that is provided with a storage container and an opening and closing stage placed on the top of the storage container (for example, refer to Japanese Unexamined Patent Application, First Publication No. 2007-277655).

Next, using flakes made of an R-T-B alloy of the present invention obtained in this manner, a fine powder for R-T-B rare earth permanent magnets of the present invention is produced. Firstly, hydrogen is absorbed into the flakes made of the R-T-B alloy of the present invention at room temperature, then the hydrogen is removed by reducing the pressure at 300° C. Afterward, the flakes of R-T-B alloy are pulverized to a fine powder for R-T-B rare earth permanent magnets with an average particle size of d50=4 to 5 μm using a pulverizer such as a jet mill. Next, the obtained fine powder for R-T-B rare earth permanent magnets is filled into a metal mold of a transverse magnetic field-type pressing machine for example, to be press-molded, and is heat treated at 1030 to 1100° C. in a vacuum, then after cooling down to room temperature momentarily, heat treated at 800° C. Afterward, it is heat treated at 500° C. to be sintered, and thus a R-T-B rare earth permanent magnet of the present invention can be obtained.

An R-T-B alloy of the present embodiment has a main phase, being an R₂T₁₄B phase, and an R-rich phase, and when the mean value of the concentration of Dy and/or Tb in the whole of the R-T-B alloy is defined as the average concentration, a region of 60% or more of the area of the main phase in an arbitrary cross-section of the R-T-B alloy contains Dy and/or Tb of the average concentration or higher. Since the concentration of Dy and/or Tb in the main phase is high, and the dispersion of the concentration of Dy and/or Tb in the main phase is low, it is possible to realize an R-T-B rare earth permanent magnet with low dispersion of its magnetic properties and excellent uniformity of magnetization.

Furthermore, in the R-T-B alloy of the present embodiment, since the concentration of Dy and/or Tb in the main phase is high, and the dispersion of the concentration of Dy and/or Tb in the main phase is low, the loss of Dy and/or Tb attributable to pulverization is low.

Moreover, in the R-T-B alloy of the present embodiment, in the case where an area of 10% or more of the area of the main phase contains Dy and/or Tb at 1% or more by mass higher than the average concentration, the concentration of Dy and/or Tb in the main phase is even higher. As a result, in the case where a fine powder for R-T-B rare earth permanent magnets is produced by pulverizing this, the loss of Dy and/or Tb caused by pulverization becomes even less, so that it is possible to increase the proportion of Dy and/or Tb used effectively for improvement of the coercive force. As a result, it is possible to improve the coercive force of the sintered magnet effectively without increasing the content of Dy and/or Tb.

Moreover, in the R-T-B alloy of the present embodiment, in the case where the distance between R-rich phases is 3 μm to 10 μm, fine R-rich phases are dispersed uniformly, so that a high coercive force can be obtained.

Furthermore, since a process for producing an R-T-B alloy of the present invention has a casting step that uses a strip casting method, and a temperature maintaining heat treatment step for maintaining the cast alloy at a temperature of 900° C. to 600° C. for 10 seconds to 7200 seconds, the diffusion of R is performed sufficiently, lowering the dispersion of the concentration of Dy and/or Tb contained in the main phase, so that an R-T-B alloy of the present invention can be obtained in which the concentration of Dy and/or Tb contained in the main phase is high, and the dispersion of the concentration of Dy and/or Tb in the main phase is low.

Moreover, by performing the casting step using a strip casting method and a temperature maintaining heat treatment step for maintaining the cast alloy at 900° C. to 600° C. for 10 seconds to 7200 seconds, it is possible to obtain an R-T-B alloy with high coercive force, in which the distance between R-rich phases is 3 μm to 10 μm, and fine R-rich phases are dispersed uniformly.

Furthermore, in the casting step of the present embodiment, in the case where the temperature of the alloy when detaching from the cooling roller is 650° C. to 1100° C., it is possible to perform the temperature maintaining heat treatment step without reheating after the casting step.

Moreover, in the present embodiment, in the case where the temperature of the alloy when starting the temperature maintaining heat treatment step is 950° C. to 600° C., it is possible to produce an R-T-B alloy in which the distribution of Dy and/or Tb in the main phase is more uniform without making the crystal structure of the alloy coarse.

Since a fine powder for R-T-B rare earth permanent magnets of the present embodiment is produced from an R-T-B alloy of the present embodiment, it is possible to realize an R-T-B rare earth permanent magnet with low dispersion of its magnetic properties and excellent uniformity of magnetization.

Furthermore, since the fine powder for R-T-B rare earth permanent magnets of the present embodiment is produced from an R-T-B alloy in which the concentration of Dy and/or Tb in the main phase is high, and the dispersion of the concentration of Dy and/or Tb in the main phase is low, this gives a rounded grain shape with corners removed, compared with a conventional fine powder for R-T-B rare earth permanent magnets, so that excellent fluidity can be obtained. As a result, the fine powder for R-T-B rare earth permanent magnets of the present embodiment fills the metal mold excellently when producing an R-T-B rare earth permanent magnet, so that it is possible to increase the packing density of the fine powder for R-T-B rare earth permanent magnets in the metal mold. By so doing, it is possible to prevent cracking or chipping of the cast R-T-B rare earth permanent magnet, and it is also possible to reduce the fluctuation in the dimensions of the R-T-B rare earth permanent magnets obtained after sintering.

Moreover, since the fine powder for R-T-B rare earth permanent magnets of the present embodiment is made from the R-T-B alloy of the present embodiment, the orientation at the time of molding applying a magnetic field is higher than with a conventional fine powder for R-T-B rare earth permanent magnets. Therefore, an R-T-B rear earth permanent magnet produced from the fine powder for R-T-B rare earth permanent magnets of the present embodiment has a high remanence, so that it has high magnetic energy.

Furthermore, since the fine powder for R-T-B rare earth permanent magnets of the present embodiment is made from the R-T-B alloy of the present embodiment, it has low dispersion of its magnetic characteristics, and has excellent uniformity of magnetization.

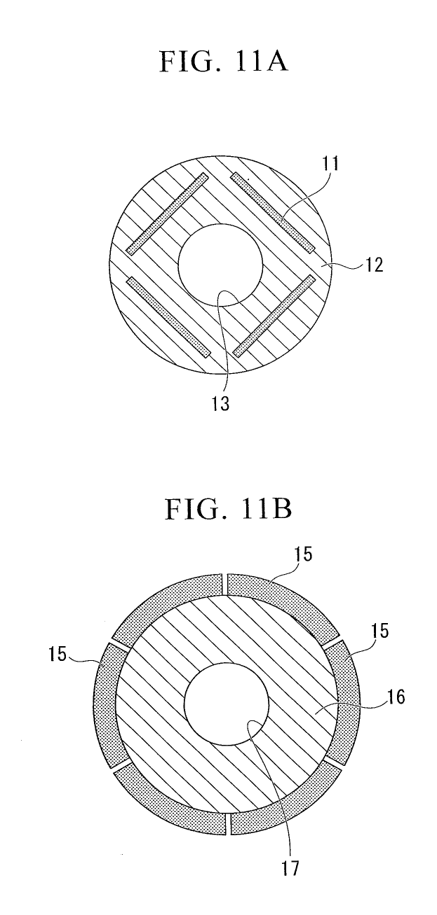

FIG. 11 is a diagram showing an example of a motor of the present invention. FIG. 11A is a schematic cross-sectional diagram showing the rotor structure section of an IPM type motor. FIG. 11B is a schematic cross-sectional diagram showing the rotor structure section of an SPM type motor.

In FIG. 11A, reference symbol 11 denotes bar-shaped permanent magnets, reference symbol 12 denotes a rotating shaft made from a magnetic substance, which contains the permanent magnet 11, and reference symbol 13 denotes an aperture provided inside of the rotating shaft 12. For the permanent magnets 11, an R-T-B rare earth permanent magnet of the present invention is used.

In the IPM type motor shown in FIG. 11A, since the R-T-B rare earth permanent magnet of the present invention is used for the permanent magnets 11, high efficiency can be exhibited.

Moreover, in FIG. 11B, reference symbol 16 denotes a rotating shaft made from a magnetic substance, reference symbol 15 denotes a plurality of permanent magnets arranged on the outer periphery of the rotating shaft 16, and reference symbol 17 denotes an aperture provided inside of the rotating shaft 16. For the permanent magnet 15, an R-T-B rare earth permanent magnet of the present invention is used. In the SPM type motor shown in FIG. 11B, since the R-T-B rare earth permanent magnet of the present invention is used for the permanent magnets 15, high efficiency can be exhibited.

### Example 1

A raw material with a composition of Nd: 25%, Pr: 6%, Dy: 2%, B: 0.99%, Co: 1.0%, Al: 0.15%, Cu: 0.1.0%, Ga: 0.1%, and the remainder being Fe, as weight ratios, was weighed, poured into the refractory crucible 1 in the manufacturing apparatus shown in FIG. 1, which was made from alumina, and melted in an atmosphere of argon gas at 1 atmospheric pressure using a high frequency melting furnace to form a molten metal alloy. Next, the molten metal alloy was supplied to the casting roller 3 (cooling roller) via the tundish 2, cast using an SC method, and was crushed using the crushing equipment 21 in order to form cast alloy flakes of the R-T-B alloy. Then it was transferred to the temperature maintaining container of the temperature control apparatus to start the temperature maintaining heat treatment step.

The rotating speed of the casting roller was 1.0 m/s, the temperature of the alloy when it detached from the cooling roller was 800° C., the temperature of the alloy when starting the temperature maintaining heat treatment step (temperature of the alloy when it was guided to the temperature control apparatus) was 750° C., and the mean thickness of the alloy was 0.3 mm. Furthermore, in the temperature maintaining heat treatment step, the cast alloy flakes were maintained in the temperature maintaining container at a temperature of 750° C. for 600 seconds. Then, after the temperature maintaining heat treatment step, the cast alloy flakes were transferred to a recovery system to cool down to below 100° C.

### Comparative Example 1

An R-T-B alloy made from a similar material to example 1 was cast and crushed similarly to example 1 to obtain cast alloy flakes of the R-T-B alloy. The cast alloy flakes obtained were transferred to a recovery system to cool down to below 100° C. but without performing the temperature maintaining heat treatment step.

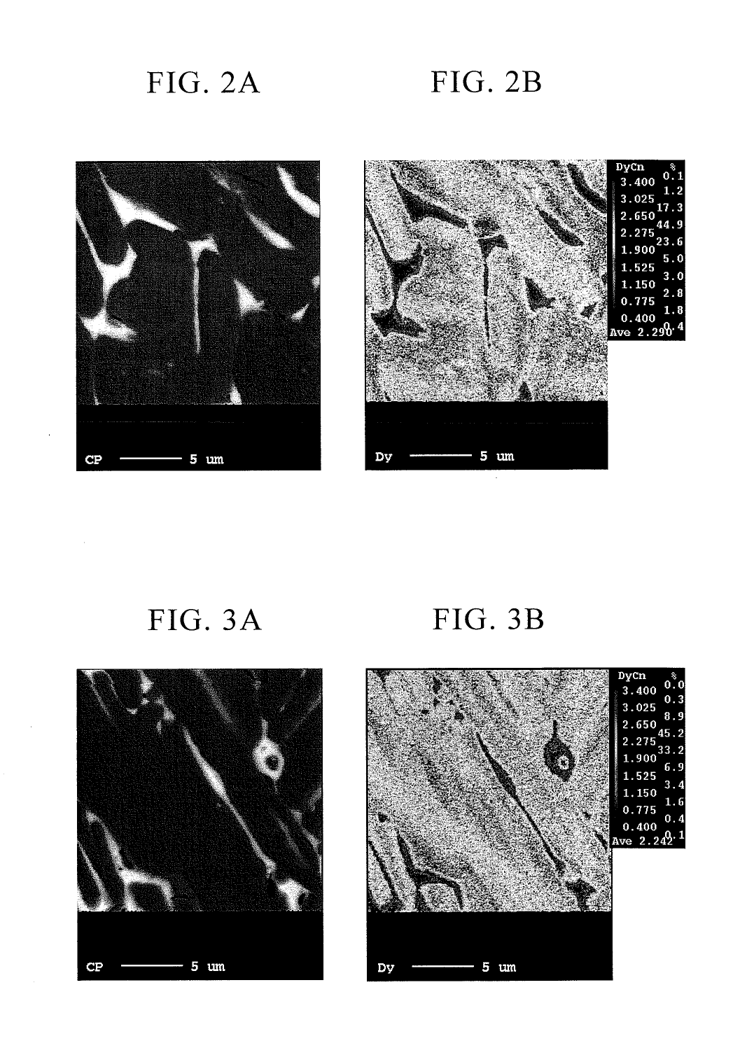

Regarding the cast alloy flakes of example 1 and comparative example 1 obtained in this manner, EPMA analysis was performed at an acceleration voltage of 20 kV using a field emission type EPMA (JXA-8500F: product name, manufactured by JEOL Ltd.). The results are shown in FIG. 2 and FIG. 3.

FIG. 2 is a photograph showing the result of the EPMA analysis of the cast alloy flakes of example 1. FIG. 2A is a backscattered electron image projected on the surface of the casting roller in the vertical direction, and FIG. 2B is an electron image showing the result of an area analysis (digital mapping) of Dy in the same area as in FIG. 2A. Furthermore, FIG. 3 is photographs showing the result of the EPMA analysis of the cast alloy flakes of comparative example 1. FIG. 3A is a backscattered electron image projected on the surface of the casting roller in the vertical direction, and FIG. 3B is an electron image showing the result of an area analysis (digital mapping) of Dy in the same area as in FIG. 3A.

FIG. 2 and FIG. 3 show that the cast alloy flakes of example 1 and comparative example 1 comprise a main phase and an R-rich phase. The gray colored areas in FIG. 2A and FIG. 3A indicate the main phases (R₂T₁₄B phases) and the white colored areas indicate the R-rich phases.

Using FIG. 2A and FIG. 3A, the distances between adjacent R-rich phases were measured as described below. That is, ten lines parallel to the surface of the casting roller were drawn on the backscattered electrons image shown in FIG. 2A and FIG. 3A, and the number of lines which are crossed by the R-rich phases was counted, and the total length of the line was divided by the number of lines of the R-rich phases to obtain the distances. The distance between the R-rich phases obtained in this manner was 6.6 μm in example 1, and 4.4 μm in comparative example 1.

Moreover, FIG. 2A and FIG. 2B show that the Dy concentration was high in the main phase in example 1. In contrast, FIG. 3A and FIG. 3B show that the Dy was distributed mainly in the main phase in comparative example 1, while parts could be seen where the Dy concentration was low in the main phase, and compared with example 1, the dispersion of the Dy concentration in the main phase was high.

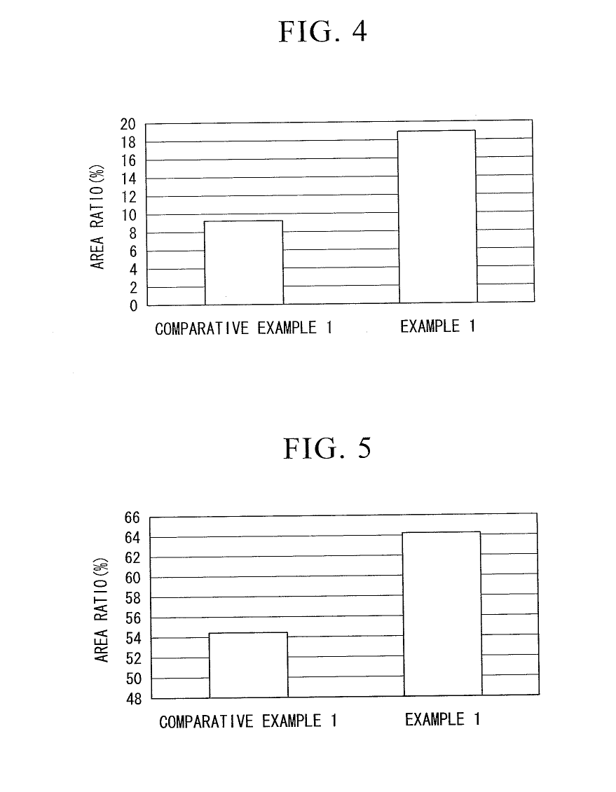

Furthermore, from the results of the area analysis of the cast alloy flakes by the EPMA in example 1 and comparative example 1, of the area of the main phase, the area ratio of the areas where the Dy concentration was greater than or equal to the average concentration, and the area ratio of the areas where the Dy concentration was 1% or more by mass higher than the average concentration were calculated. The results are shown in FIG. 4 and FIG. 5.

The average concentration of Dy in the cast alloy flakes of example 1 and comparative example 1 was a mass ratio (2% by mass) of the raw material.

FIG. 4 is a graph showing area ratios of the areas of the main phase, where the Dy concentration was 1% or more by mass higher than the average concentration. FIG. 5 is a graph showing area ratios of the areas of the main phase, where the Dy concentration was the average concentration or more.

As shown in FIG. 4, in example 1, the area ratio of the areas of the main phase where the Dy concentration was 3% or more by mass was 19%. In contrast, in comparative example 1, the area ratio of the areas of the main phase that had a Dy concentration of 3% or more by mass was 9%, which was small compared with example 1.

Furthermore, as shown in FIG. 5, in example 1, the area ratio of the areas of the main phase that had a Dy concentration of 2% or more by mass was 64%. In contrast, in comparative example 1, the area ratio of the areas of the main phase that had a Dy concentration of 2% or more by mass was 54%, which was small compared with example 1.

Moreover, using the results of the surface analysis of the cast alloy flakes by the EPMA in example 1 and comparative example 1, the amount of Dy contained in the main phase out of the Dy contained in the whole of the R-T-B alloy was obtained. The results were 77% by mass in example 1, and 65% by mass in comparative example 1. Furthermore, the results of obtaining the dispersions of the Dy concentration in the main phases were 1.7% by mass in example 1, and 2.5% by mass in comparative example 1.

Next, magnets were produced using the cast alloy flakes of example 1 and comparative example 1 as described below. Firstly, the cast alloy flakes were decrepitated by hydrogen. The hydrogen decrepitation was performed using a method in which hydrogen was absorbed into the cast alloy flakes at room temperature, the flakes were heated up to 300° C., and afterward cooled down to room temperature by vacuum degasification to embrittle them, and afterward zinc stearate was added at 0.05% by mass, and they were pulverized in a nitrogen gas stream using a jet mill. The average particle size of the powder obtained by pulverization, which was obtained using a laser diffraction type measurement, was 5.0 μm in both example 1 and comparative example 1.

Next, the obtained fine powder for R-T-B rare earth permanent magnets of example 1 and comparative example 1 was orientated and molded using a transverse magnetic field pressing machine, and heated to 1080° C. in a sintering furnace to obtain a sintered compact. After the sintered compact was cooled down to room temperature, heat treatment was performed at 800° C., then at 500° C., for respective predetermined durations to obtain R-T-B rare earth permanent magnets of example 1 and comparative example 1.

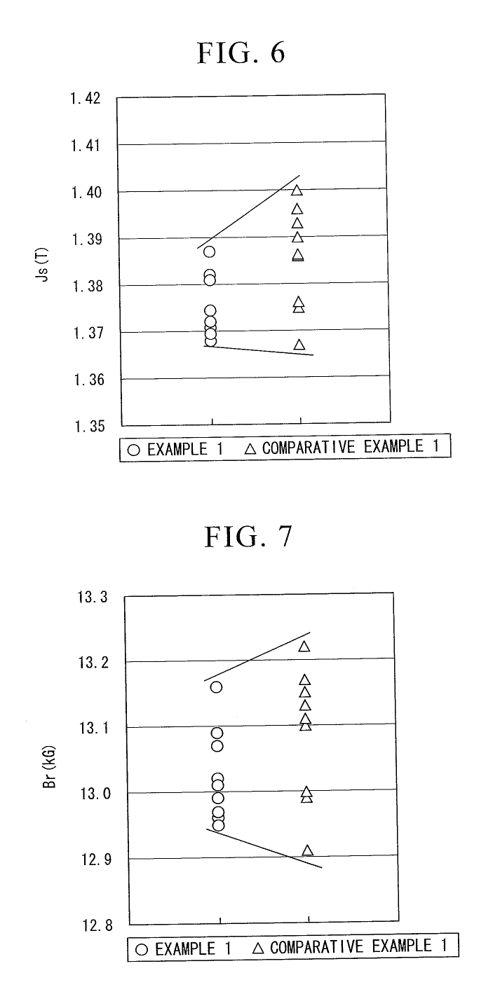

The R-T-B rare earth permanent magnets of example 1 and comparative example 1 obtained in this manner were processed into 7 mm squares, and their magnetic characteristics were measured using a pulsed BH tracer. The results are shown in FIG. 6 to FIG. 10.

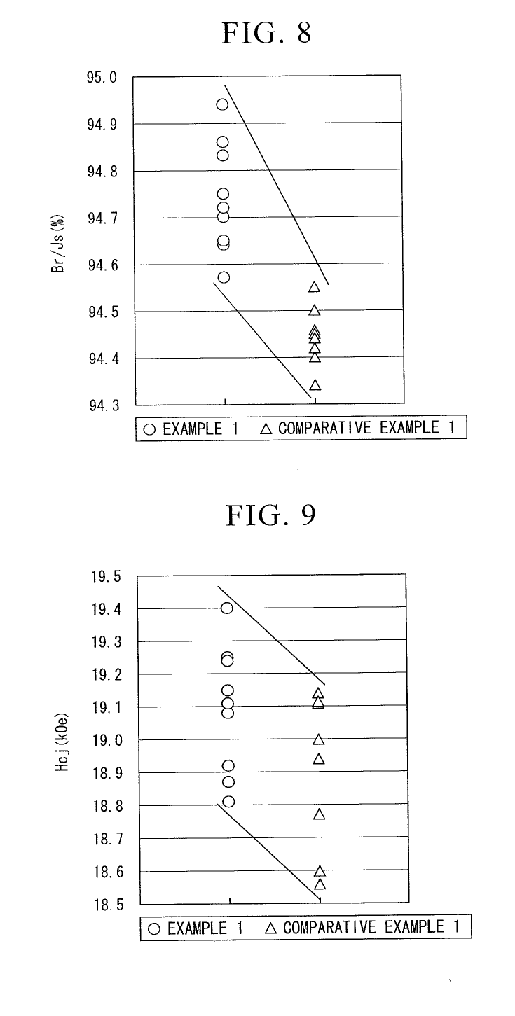

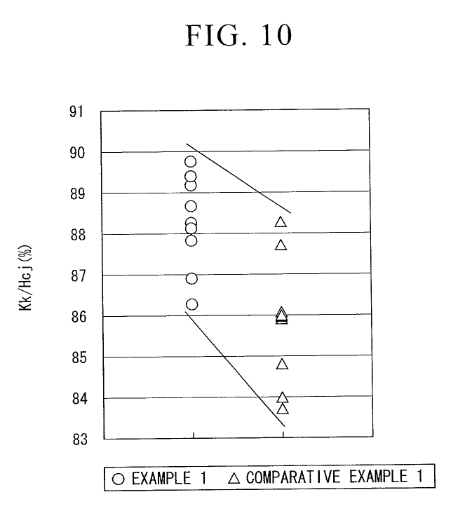

FIG. 6 is a graph showing the saturation magnetization (Js) of the R-T-B rare earth permanent magnets of example 1 and comparative example 1. FIG. 7 is a graph showing the remanence (Br) of the R-T-B rare earth permanent magnets of example 1 and comparative example 1. FIG. 8 is a graph showing the orientation (Br/Js) of the R-T-B rare earth permanent magnets of example 1 and comparative example 1. FIG. 9 is a graph showing the coercive force (Hcj) of the R-T-B rare earth permanent magnets of example 1 and comparative example 1. FIG. 10 is a graph showing the squareness (Hk/Hcj) of the R-T-B rare earth permanent magnets of example 1 and comparative example 1.

As shown in FIG. 6, the dispersion of the saturation magnetization (Js) was small in example 1 compared with comparative example 1. Furthermore, as shown in FIG. 7, the dispersion of the remanence (Br) was small in example 1 compared with comparative example 1.

Moreover, as shown in FIG. 8, the orientation (Br/Js) of magnetic particles was high in example 1 compared with comparative example 1.

Furthermore, as shown in FIG. 9, the coercive force (Hcj) was high in example 1 compared with comparative example 1. Moreover, as shown in FIG. 10, in example 1, the squareness (Hk/Hcj) was high compared with comparative example 1.

As shown in FIG. 6 to FIG. 10, it is clear that example 1 had excellent magnetic characteristics as a sintered magnet compared with comparative example 1.

### Example 2

Except for using a raw material with a composition of Nd: 22%, Pr: 6%, Dy: 5%, B: 0.99%, Co: 1.0%, Al: 0.15%, Cu: 0.10%, Ga: 0.1%, and the remainder being Fe, as weight ratios, casting and crushing were performed similarly to example 1, and a temperature maintaining heat treatment step was performed similarly to example 1 to obtain cast alloy flakes of R-T-B alloy.

### Comparative Example 2

An R-T-B alloy made from a similar raw material to example 2 was cast and crushed similarly to example 2 to obtain cast alloy flakes of the R-T-B alloy. The cast alloy flakes obtained were transferred to a recovery system to cool down similarly to example 2 but without performing the temperature maintaining heat treatment step.

Regarding the cast alloy flakes of example 2 and comparative example 2 obtained in this manner, similarly to example 1, of the area of the main phase, the area ratio of the areas where the Dy concentration was greater than or equal to the average concentration, and the area ratio of the areas where the Dy concentration was 1% or more by mass higher than the average concentration (5% by mass) were calculated.

In example 2, the area ratio of the areas of the main phase that had a Dy concentration of 5% or more by mass was 67%. In contrast, in comparative example 2, the area ratio of the areas of the main phase that had a Dy concentration of 5% or more by mass was 52%, which was small compared with example 2.

Furthermore, in example 2, the area ratio of the areas of the main phase that had a Dy concentration of 6% or more by mass was 15%. In contrast, in comparative example 2, the area ratio of the areas of the main phase that had a Dy concentration of 6% or more by mass was 8%, which was small compared with example 2.

Moreover, using the results of the area analysis of the cast alloy flakes by the EPMA in example 2 and comparative example 2, the amount of Dy contained in the main phase out of the Dy contained in the whole of the R-T-B alloy was obtained. The results were 79% by mass in example 2, and 64% by mass in comparative example 2. Furthermore, the results of obtaining the dispersions of the Dy concentration in the main phases were 1.5% by mass in example 2, and 2.8% by mass in comparative example 2.

### Example 3

Except for using a raw material with a composition of Nd: 17%, Pr: 5%, Dy: 9%, B: 0.92%, Co: 2.0%, Al: 0.15%, Cu: 0.10%, Ga: 0.1%, and the remainder being Fe, as weight ratios, casting and crushing were performed similarly to example 1, and a temperature maintaining heat treatment step was performed similarly to example 1 to obtain cast alloy flakes of R-T-B alloy.

### Comparative Example 3

An R-T-B alloy made from a similar raw material to example 3 was cast and crushed similarly to example 1 to obtain cast alloy flakes of the R-T-B alloy. The cast alloy flakes obtained were transferred to a recovery system to cool down similarly to example 3 but without performing the temperature maintaining heat treatment step.

Regarding the cast alloy flakes of example 3 and comparative example 3 obtained in this manner, similarly to example 1, of the area of the main phase, the area ratio of the areas where the Dy concentration was greater than or equal to the average concentration, and the area ratio of the areas where the Dy concentration was 1% or more by mass higher than the average concentration (9% by mass) were calculated.

In example 3, the area ratio of the areas of the main phase that had a Dy concentration of 9% or more by mass was 62%. In contrast, in comparative example 3, the area ratio of the areas of the main phase that had a Dy concentration of 9% or more by mass was 53%, which was small compared with example 3.

Furthermore, in example 3, the area ratio of the areas of the main phase that had a Dy concentration of 10% or more by mass was 12%. In contrast, in comparative example 3, the area ratio of the areas of the main phase that had a Dy concentration of 10% or more by mass was 7%, which was small compared with example 3.

Furthermore, using the results of the area analysis of the cast alloy flakes by the EPMA in example 3 and comparative example 3, the amount of Dy contained in the main phase out of the Dy contained in the whole of the R-T-B alloy was obtained. The results were 78% by mass in example 3, and 67% by mass in comparative example 3. Furthermore, the results of obtaining the dispersions of the Dy concentration in the main phases were 1.6% by mass in example 3, and 2.6% by mass in comparative example 3.

### INDUSTRIAL APPLICABILITY

The present invention makes it possible to provide optimal R-T-B rare earth permanent magnets for motor applications, and motors using the permanent magnets are useful in a range of industrial fields. Therefore the present invention has high industrial applicability.

1. An R-T-B alloy used in a rare earth permanent magnet, where R is at least one element selected from rare earth elements including Y, which contains Dy and/or Tb as an essential element, T is a metal comprising Fe as an essential element, and B is boron, comprising: a main phase being an R₂T₁₄B phase, and an R-rich phase; and when a mean value of the concentration of Dy and/or Tb in the whole of said R-T-B alloy is defined as an average concentration, an area of 60% or more of an area of said main phase in an arbitrary cross-section of said R-T-B alloy contains said Dy and/or Tb at the average concentration or higher.

2. An R-T-B alloy according to claim 1, wherein an area of 10% or more of an area of said main phase contains said Dy and/or Tb at 1% or more by mass higher than the average concentration.

3. An R-T-B alloy according to claim 1, wherein a distance between said R-rich phases is 3 μm to 10 μm.

4. An R-T-B alloy according to claim 1, wherein an amount of Dy and/or Tb contained in said main phase of the Dy and/or Tb contained in the whole of said R-T-B alloy is 75% by mass to 90% by mass, and a dispersion of a concentration of Dy and/or Tb in said main phase is 2% or less by mass.

5. An R-T-B alloy according to claim 1, that is a flake with an average thickness of 0.05 mm to 0.8 mm, produced using a strip casting method.

6. A process for producing an R-T-B alloy according to claim 1, comprising;
a casting step using a strip casting method, and
a temperature maintaining heat treatment step for maintaining a cast alloy at a temperature of 900° C. to 600° C. for 10 seconds to 7200 seconds.

7. A process for producing an R-T-B alloy according to claim 6, wherein in said casting step, an alloy temperature when it is removed from a cooling roller is between 650° C. and 1100° C.

8. A process for producing an R-T-B alloy according to claim 6, wherein a temperature of said alloy when starting said temperature maintaining heat treatment step is between 950° C. and 600° C.

9. A fine powder for R-T-B rare earth permanent magnets that is produced from an R-T-B alloy according to claim 1.

10. A fine powder for R-T-B rare earth permanent magnets that is produced from an R-T-B alloy produced using a process for producing an R-T-B alloy according to claim 6.

11. An R-T-B rare earth permanent magnet that is produced from a fine powder for R-T-B rare earth permanent magnets according to claim 9.

12. An R-T-B rare earth permanent magnet that is produced from a fine powder for R-T-B rare earth permanent magnets according to claim 10.

13. A motor, wherein an R-T-B rare earth permanent magnet according to claim 11 is used.

14. A motor, wherein an R-T-B rare earth permanent magnet according to claim 12 is used.
